(19) United States
(12) Patent Application Publication
(10) Pub. No.: US 2026/0095736 A1
(43) Pub. Date: Apr. 2, 2026

(54) METHOD FOR MANAGING USER EQUIPMENT REGISTRATION WITH ACCESS AND MOBILITY MANAGEMENT FUNCTION DURING DISASTER CONDITION

(71) Applicant: SAMSUNG ELECTRONICS CO., LTD., Suwon-si, Gyeonggi-do (KR)

(72) Inventors: Lalith KUMAR, Bangalore (IN); Kailash Kumar JHA, Bangalore (IN); Aman AGARWAL, Bangalore (IN); Mahmoud WATFA, Staines (GB)

(21) Appl. No.: 19/113,303

(22) PCT Filed: Sep. 7, 2023
(86) PCT No.: PCT/KR2023/013447

§ 371 Date: Mar. 19, 2025

(30) Foreign Application Priority Data
Sep. 19, 2022 (IN) 202241053579
Sep. 23, 2022 (IN) 202241054685
Aug. 14, 2023 (IN) 202241053579

(51) Int. Cl. H04W 4/90; H04W 8/02

(52) U.S. Cl. CPC H04W 4/90; H04W 8/02

(57) ABSTRACT

The disclosure relates to a 5G or 6G communication system for supporting a higher data transmission rate. A first access and mobility management function (AMF) receives, from a user equipment (UE), a registration request message including information regarding a public land mobile network (PLMN) with a disaster condition, wherein the information regarding the PLMN with the disaster condition indicates a PLMN of the UE which has faced the disaster condition, stores the information regarding the PLMN with the disaster condition included in the registration request message as a part of a UE context, receives, from a second AMF, a UE context transfer request message, and transmits, to the second AMF, a UE context transfer response message in response to the UE context transfer request message, the UE context transfer response message comprising the UE context.

### TECHNICAL FIELD

The present invention generally relates to the field of communications networks, and more specifically relates to a method for managing a User Equipment (UE) registration with an Access and Mobility Management Function (AMF) during a disaster condition.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

In a first aspect of the disclosure, provided herein is a method performed by a first access and mobility management function (AMF), the method comprising: receiving, from a user equipment (UE), a registration request message including information regarding a public land mobile network (PLMN) with a disaster condition, wherein the information regarding the PLMN with the disaster condition indicates a PLMN of the UE which has faced the disaster condition; storing the information regarding the PLMN with the disaster condition included in the registration request message as a part of a UE context; receiving, from a second AMF, a UE context transfer request message; and transmitting, to the second AMF, a UE context transfer response message in response to the UE context transfer request message, the UE context transfer response message comprising the UE context.

Additionally or alternatively, storing the information regarding the PLMN with the disaster condition may include storing the information regarding the PLMN with the disaster condition as the part of the UE context when the UE is registered for a disaster roaming service.

Additionally or alternatively, the UE context may further include disaster roaming information indicating whether the UE is registered for a disaster roaming service.

Additionally or alternatively, the registration request message may include registration type information indicating a disaster roaming initial registration and a disaster roaming mobility registration updating.

In a second aspect of the disclosure, provided herein is a first access and mobility management function (AMF) comprising: a transceiver; and at least one processor configured to the transceiver: receive, from a user equipment (UE), a registration request message including information regarding a public land mobile network (PLMN) with a disaster condition, wherein the information regarding the PLMN with the disaster condition indicates a PLMN of the UE which has faced the disaster condition; store the information regarding the PLMN with the disaster condition included in the registration request message as a part of a UE context; receive, from a second AMF, a UE context transfer request message; and transmit, to the second AMF, a UE context transfer response message in response to the UE context transfer request message, the UE context transfer response message comprising the UE context.

In a third aspect of the disclosure, provided herein is a method performed by a second access and mobility management function (AMF), the method comprising: transmitting, to a first AMF, a user equipment (UE) context transfer request message; receiving, from the first AMF, a UE context transfer response message comprising a UE context, wherein the UE context includes information regarding a public land mobile network (PLMN) with a disaster condition; determining whether the second AMF supports a disaster roaming service for the PLMN with the disaster condition to a UE; and in case that the second AMF determines not to support the disaster roaming service for the PLMN with disaster condition to the UE, transmitting, to the UE, a registration reject message indicating that the disaster roaming service for the PLMN with the disaster condition is not allowed.

Additionally or alternatively, the information regarding the PLMN with the disaster condition may indicate a PLMN of the UE which has faced the disaster condition.

Additionally or alternatively, the information regarding the PLMN with the disaster condition may be provided by the UE through a registration request message transmitted to the first AMF.

Additionally or alternatively, the UE context may further include disaster roaming information indicating whether the UE is registered for the disaster roaming service.

Additionally or alternatively, the registration reject message may include cause information, and the cause information indicates that the disaster roaming service for the PLMN with the disaster condition is not allowed.

In a fourth aspect of the disclosure, provided herein is a second access and mobility management function (AMF) comprising: a transceiver; and at least one processor configured to the transceiver: transmit, to a first AMF, a user equipment (UE) context transfer request message; receive, from the first AMF, a UE context transfer response message comprising a UE context, wherein the UE context includes information regarding a public land mobile network (PLMN) with a disaster condition; determine whether the second AMF supports a disaster roaming service for the PLMN with the disaster condition to a UE; and in case that the second AMF determines not to support the disaster roaming service for the PLMN with disaster condition to the UE, transmit, to the UE, a registration reject message indicating that the disaster roaming service for the PLMN with the disaster condition is not allowed.

In a fifth aspect of the disclosure, provided herein is a method performed by a user equipment (UE), the method comprising: transmitting, to a first access and mobility management function (AMF), a registration request message including information regarding a public land mobile network (PLMN) with a disaster condition, wherein the information regarding the PLMN with the disaster condition indicates a PLMN of the UE which has faced disaster condition; and receiving, from a second AMF, a registration reject message indicating that a disaster roaming service for the PLMN with the disaster condition is not allowed, wherein the UE does not attempt to register for disaster roaming on the PLMN with the disaster condition for a certain period of time.

Additionally or alternatively, the information regarding the PLMN with the disaster condition included in the registration request message may be stored by the first AMF as a part of a UE context when the UE is registered for the disaster roaming service.

Additionally or alternatively, the method may further comprise: performing a PLMN selection.

In a sixth aspect of the disclosure, provided herein is a user equipment (UE) comprising: a transceiver; and at least one processor configured to the transceiver: transmit, to a first access and mobility management function (AMF), a registration request message including information regarding a public land mobile network (PLMN) with a disaster condition, wherein the information regarding the PLMN with the disaster condition indicates a PLMN of the UE which has faced disaster condition; and receive, from a second AMF, a registration reject message indicating that a disaster roaming service for the PLMN with the disaster condition is not allowed, wherein the UE does not attempt to register for disaster roaming on the PLMN with the disaster condition for a certain period of time.

### BRIEF DESCRIPTION OF DRAWINGS

These and other features, aspects, and advantages of the disclosure will become better understood when the following detailed description is read with reference to the accompanying drawings in which like characters represent like parts throughout the drawings, wherein:

FIG. 1A and FIG. 1B are exemplary sequence flow diagrams illustrating a problem associated with a User Equipment (UE) registration with an Access and Mobility Management Function (AMF) during a disaster condition, when a UE moves from an old AMF to a new AMF, according to an embodiment of the disclosure;

FIG. 2A and FIG. 2B are exemplary sequence flow diagrams illustrating a problem associated with the UE registration with a PLMN-A during the disaster condition, according to an embodiment of the disclosure;

FIG. 3A, FIG. 3B and FIG. 3C are exemplary sequence flow diagrams illustrating a method for managing the UE registration with the AMF during the disaster condition, according to an embodiment of the disclosure;

FIG. 4A, FIG. 4B and FIG. 4C are exemplary sequence flow diagrams illustrating a method for managing the UE registration with the PLMN-A during the disaster condition, according to an embodiment of the disclosure;

FIG. 5 illustrates a block diagram of the UE for managing the UE registration during the disaster condition, according to an embodiment of the disclosure;

FIG. 6 illustrates a block diagram of a first AMF for managing the UE registration during the disaster condition, according to an embodiment of the disclosure;

FIG. 7 illustrates a block diagram of a second AMF for managing the UE registration during the disaster condition, according to an embodiment of the disclosure;

FIG. 8 is a flow diagram illustrating a method for managing the UE registration with the first AMF during the disaster condition, according to an embodiment of the disclosure;

FIG. 9 is a flow diagram illustrating a method for managing the UE registration with the second AMF during the disaster condition, according to an embodiment of the disclosure; and

FIG. 10 is a flow diagram illustrating a method for managing the UE registration during the disaster condition, according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### MODE FOR THE INVENTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Following abbreviations may be used in one or more embodiments throughout this disclosure, as described in Table-1 below.

TABLE 1

| | |
|---|---|
| 4G-GUTI | 4G-Globally Unique Temporary Identifier |
| 5GCN | 5G Core Network |
| 5G-GUTI | 5G-Globally Unique Temporary Identifier |
| 5GMM | 5GS Mobility Management |
| 5G-RG | 5G Residential Gateway |
| 5G-BRG | 5G Broadband Residential Gateway |
| 5G-CRG | 5G Cable Residential Gateway |
| 5GS | 5G System |
| 5GSM | 5GS Session Management |
| 5G-S-TMSI | 5G S-Temporary Mobile Subscription Identifier |
| 5G-TMSI | 5G Temporary Mobile Subscription Identifier |
| 5QI | 5G QoS Identifier |
| ACS | Auto-Configuration Server |
| AKA | Authentication and Key Agreement |
| AKMA | Authentication and Key Management for |
| | Applications |
| A-KID | AKMA Key Identifier |
| A-TID | AKMA Temporary Identifier |
| AMBR | Aggregate Maximum Bit Rate |
| AMF | Access and Mobility Management Function |
| APN | Access Point Name |
| ATSSS | Access Traffic Steering, Switching, and |
| | Splitting |
| AUSF | Authentication Server Function |
| CAG | Closed access group |
| CHAP | Challenge Handshake Authentication Protocol |
| SUCI | Subscription Concealed Identifier |
| PLMN | Public Land Mobile Network |
| MS | Mobile Station. The present disclosure makes |
| | no distinction between MS and UE. |
| UE | User Equipment |
| ME | Mobile Equipment |
| USIM | Universal Subscriber Identity Module |
| UDM | Unified Data Management Function |
| SIM | Subscriber Identity Module |
| VPLMN | Visited PLMN |
| HPLMN | Home PLMN |
| MINT | Minimization of service interruption |

The following definitions of the abbreviations may be used in one or more embodiments throughout this disclosure, as described in Table-2 below.

TABLE 2

| | |
|---|---|
| Visited PLMN | This is a PLMN different from the HPLMN (if |
| (VPLMN) | the EHPLMN list is not present or is empty) or |
| | different from an EHPLMN (if the EHPLMN list is |
| | present). |
| Allowable | In the case of an MS operating in MS |
| PLMN | operation mode A or B, this is a PLMN that is not in |
| | the list of “forbidden PLMNs” in the MS. In the case |
| | of an MS operating in MS operation mode C or an MS |
| | not supporting A/Gb mode and not supporting Iu mode, |
| | this is a PLMN that is not in the list of “forbidden |
| | PLMNs” and not in the list of “forbidden PLMNs for |
| | GPRS service” in the MS. |
| Available | PLMN(s) in the given area which is/are |
| PLMN | broadcasting capability to provide wireless |
| | communication services to the UE. |
| Camped on | The MS (ME if there is no SIM) has completed |
| a cell | the cell selection/reselection process and has |
| | chosen a cell from which it plans to receive all |
| | available services. Note that the services may be |
| | limited and that the PLMN or the SNPN may not be |
| | aware of the existence of the MS (ME) within the |
| | chosen cell. |
| EHPLMN | Any of the PLMN entries contained in the |
| | Equivalent HPLMN list. |
| Equivalent | To allow provision for multiple HPLMN codes, |
| HPLMN list | PLMN codes that are present within this list shall |
| | replace the HPLMN code derived from the IMSI for |
| | PLMN selection purposes. This list is stored on the |
| | USIM and is known as the EHPLMN list. The EHPLMN |
| | list may also contain the HPLMN code derived from |
| | the IMSI. If the HPLMN code derived from the INSI is |
| | not present in the EHPLMN list then it shall be |
| | treated as a Visited PLMN for PLMN selection |
| | purposes. |
| Home PLMN | This is a PLMN where the MCC and MNC of the |
| | PLMN identity match the MCC and MNC of the IMSI. |
| Registered | This is the PLMN on which certain LR |
| PLMN | (location registration which is also called as |
| (RPLMN) | registration procedure) outcomes have occurred. In a |
| | shared network the RPLMN is the PLMN defined by the |
| | PLMN identity of the CN operator that has accepted |
| | the LR. |
| Registration | This is the process of camping on a cell of |
| | the PLMN or the SNPN and doing any necessary LRs. |
| UPLMN | PLMN/access technology combination in the |
| | “User Controlled PLMN Selector with Access |
| | Technology” data file in the SIM (in priority |
| | order); |
| OPLMN | PLMN/access technology combination in the |
| | “Operator Controlled PLMN Selector with Access |
| | Technology” data file in the SIM (in priority order) |
| | or stored in the ME. |
| Disaster | This is the condition that a government |
| condition | decides when to initiate and terminate, e.g., a |
| | natural disaster. When this condition applies, users |
| | may have the opportunity to mitigate service |
| | interruptions and failures. |
| Disaster | A user that (a) cannot get service from the |
| inbound | PLMN it would normally be served by, due to failure |
| roamer | of service during the disaster condition, and (b) is |
| | able to register with other PLMNs. |
| Disaster | This is the special roaming policy that |
| roaming | applies during the disaster condition. |
| PLMN with | A PLMN to which the disaster condition |
| disaster | applies. |
| condition | |
| Registered | A UE is considered as “registered for |
| for disaster | disaster roaming services” when it has successfully |
| roaming | completed initial registration or mobility |
| services | registration for disaster roaming services. |
| UE side | If UE is registered for disaster roaming |
| handling | service, due to a change in TAI UE has to set |
| | “mobility registration update” + PLMN-D should be |
| | included. |
| AMF side | If UE is registered for disaster roaming |
| handling | service, due to a change in TAI UE has to set |
| | “mobility registration update” + PLMN-D should be |
| | included. |

The following is a list of Non-Access Stratum (NAS) messages that may be used in one or more embodiments throughout this disclosure, but are not limited to, as shown in Table-3 below.

TABLE 3

REGISTRATION REQUEST message;
DEREGISTRATION REQUEST message;
SERVICE REQUEST message; and
CONTROL PLANE SERVICE REQUEST.
IDENTITY REQUEST
AUTHENTICATION REQUEST;
AUTHENTICATION RESULT;
AUTHENTICATION REJECT;
REGISTRATION REJECT
REGISTRATION ACCEPT
DEREGISTRATION ACCEPT
SERVICE REJECT
UE CONFIGURATION UPDATE command
UE PARAMETERS UPDATE command

The following is a list of Evolved Packet System (EPS) Mobility Management (EMM) sublayer states that may be used in one or more embodiments throughout this disclosure, but are not limited to, as shown in Table-4 below.

TABLE 4

EMM-NULL
EMM-DEREGISTERED
EMM-DEREGISTERED.NORMAL-SERVICE
EMM-DEREGISTERED.LIMITED-SERVICE
EMM-DEREGISTERED.ATTEMPTING-TO-ATTACH
EMM-DEREGISTERED.PLMN-SEARCH
EMM-DEREGISTERED.NO-IMSI
EMM-DEREGISTERED.ATTACH-NEEDED
EMM DEREGISTERED.NO CELL AVAILABLE
EMM-DEREGISTERED.eCALL-INACTIVE
EMM-REGISTERED-INITIATED
EMM-REGISTERED
EMM-REGISTERED.NORMAL-SERVICE
EMM-REGISTERED.ATTEMPTING-TO-UPDATE
EMM-REGISTERED.LIMITED-SERVICE
EMM-REGISTERED.PLMN-SEARCH
EMM-REGISTERED.UPDATE-NEEDED
EMM-REGISTERED.NO-CELL-AVAILABLE
EMM-REGISTERED.ATTEMPTING-TO-UPDATE-MM
EMM-REGISTERED.IMSI-DETACH-INITIATED
EMM-DEREGISTERED-INITIATED
EMM-TRACKING-AREA-UPDATING-INITIATED
EMM-SERVICE-REQUEST-INITIATED

The following is a list of 5GMM sublayer states that may be used in one or more embodiments throughout this disclosure, but are not limited to, as shown in Table-5 below.

TABLE 5
5GMM-NULL
5GMM-DEREGISTERED
5GMM-DEREGISTERED.NORMAL-SERVICE
5GMM-DEREGISTERED.LIMITED-SERVICE
5GMM-DEREGISTERED.ATTEMPTING-REGISTRATION
5GMM-DEREGISTERED.PLMN-SEARCH
5GMM-DEREGISTERED.NO-SUPI
5GMM-DEREGISTERED.NO-CELL-AVAILABLE
5GMM-DEREGISTERED.eCALL-INACTIVE
5GMM-DEREGISTERED.INITIAL-REGISTRATION-NEEDED
5GMM-REGISTERED-INITIATED
5GMM-REGISTERED
5GMM-REGISTERED.NORMAL-SERVICE
5GMM-REGISTERED.NON-ALLOWED-SERVICE
5GMM-REGISTERED.ATTEMPTING-REGISTRATION-UPDATE
5GMM-REGISTERED.LIMITED-SERVICE
5GMM-REGISTERED.PLMN-SEARCH
5GMM-REGISTERED.NO-CELL-AVAILABLE
5GMM-REGISTERED.UPDATE-NEEDED
5GMM-DEREGISTERED-INITIATED
5GMM-SERVICE-REQUEST-INITIATED

Throughout this disclosure, the term “Radio Access Technology (RAT)” as defined in one or more embodiments can be one of the following, but are not limited to: Next-Generation Radio Access Network (NG-RAN), cellular networks (e.g., 5G, 4G, 3G, 2G), Evolved Packet System (EPS), 5GS, and New Radio (NR). The NR in unlicensed bands, NR (Low Earth Orbit (LEO)) satellite access, NR (Medium Earth orbit (MEO)) satellite access, NR (Geostationary Earth Orbit (GEO)) satellite access, NR (OTHERSAT) satellite access, NR Reduced Capability (RedCap), Evolved Universal Terrestrial Radio Access Network (E-UTRA), E-UTRA in unlicensed bands, Narrowband-Internet of Things (NB-IoT), Wideband IoT (WB-IoT), and Long-Term Evolution Machine Type Communication (LTE-M).

In one embodiment of the disclosure, the PLMN selection without RPLMN may include the MS selecting and attempting registration on all PLMN/access technology combinations that are available and allowable, in the following order, for example:
a. Either the HPLMN (if the EHPLMN list is not present or is empty) or the highest priority EHPLMN that is available (if the EHPLMN list is present);
b. Each PLMN/access technology combination in the “User-controlled PLMN selector with access technology” data file in the SIM (in priority order);
c. Each PLMN/access technology combination in the “Operator controlled PLMN selector with access technology” data file in the SIM (in priority order) or stored in the ME (in priority order);
d. Other PLMN/access technology combinations with received high-quality signals in random order; and
c. Other PLMN/access technology combinations in order of decreasing signal quality.

In one embodiment of the disclosure, the PLMN selection as per standard 23.122 v17.7.1 with RPLMN may include, the MS selecting and attempting registration on any PLMN/access technology combinations, if available and allowable, in the following order, for example:
a. Either the RPLMN or the last registered PLMN;
b. Either the HPLMN (if the EHPLMN list is not present or is empty) or the highest priority EHPLMN that is available (if the EHPLMN list is present);
c. Each PLMN/access technology combination in the “User-controlled PLMN selector with access technology” data file in the SIM (in priority order);
d. Each PLMN/access technology combination in the “Operator controlled PLMN selector with access technology” data file in the SIM (in priority order) or stored in the ME (in priority order);
c. Other PLMN/access technology combinations with received high-quality signals in random order; and

f. Other PLMN/access technology combinations in order of decreasing signal quality.

Throughout this disclosure, the terms “disaster roaming service” and “disaster” are used interchangeably and mean the same. Throughout this disclosure, the terms “disaster situation” and “disaster condition” are used interchangeably and mean the same.

The terms “area/location/geographical area” is used throughout this disclosure and may relate to any one of, for example, a cell/cell ID, a Tracking Area Code (TAC)/Tracking Area Identity (TAI), a PLMN, a Mobile Country Code (MCC)/Mobile Network Code (MNC), a latitude/longitude, a Carrier aggregation (CAG) cell, or any geographical location/coordinate. The network employed in this implementation could be one of, for example, a 5G/Evolved UMTS Terrestrial Radio Access Network (EUTRAN) core network entity such as an Access and Mobility Management Function (AMF)/Session Management Function (SMF)/Mobility Management Entity (MME)/User Plane Function (UPF) or any (but not limited to) 5G/EUTRAN RAN entity such as eNodeB (eNB) or gNodeB (gNB) or NG-RAN, etc. The solutions described in this disclosure are applicable to any (but not limited to) of the RAT(s).

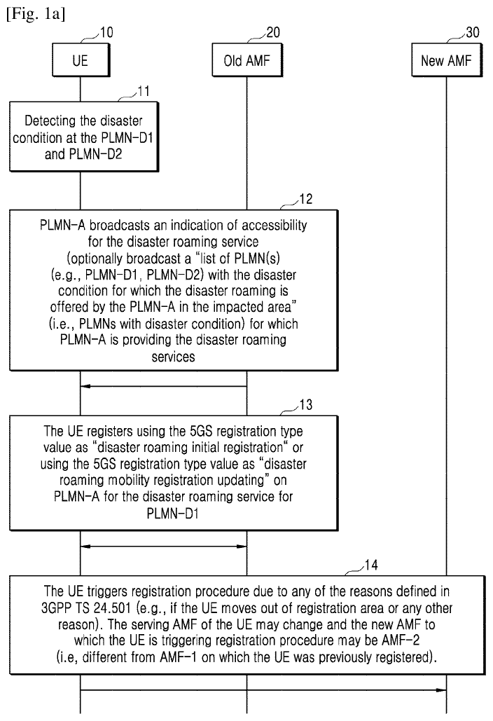

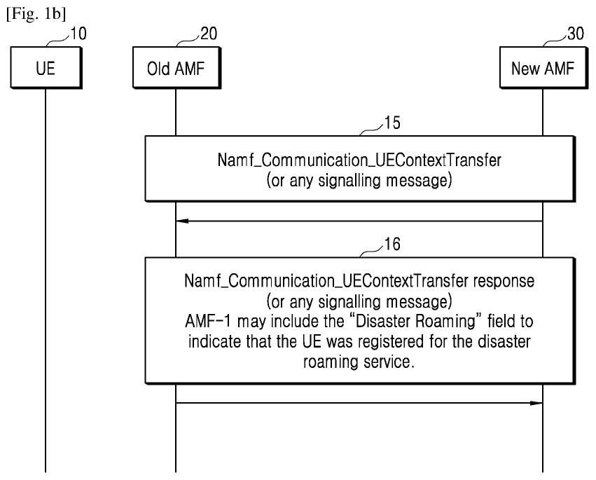

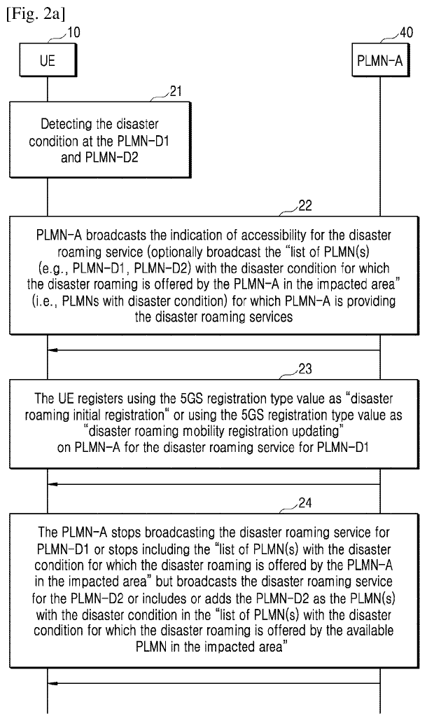

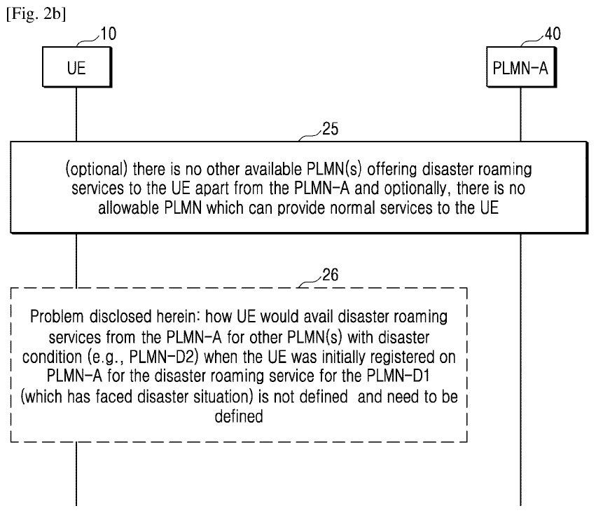

The Minimization of Service Interruption (MINT) system attempts to minimize service disruption for users in the case of a disaster condition, such as a fire, when their subscribed network is unable to offer service. The MINT system minimizes the service disruption by allowing the users to access services on alternate networks, while simultancously ensuring that these alternative networks are not overloaded. For example, the users have a cellular service subscription with a Network-A. However, due to a fire in the vicinity, the infrastructure of the Network-A (e.g., Public Land Mobile Network (PLMN)) has been severely damaged and unable to provide the cellular service to the users. In this case, the MINT system is activated. The MINT system enables the user to switch to a Network-B, which is still functioning and capable of providing the cellular service. As a result, the MINT system reduces the service disruption for the users during the disaster condition. However, despite its benefits, the MINT system has some drawbacks as described in conjunction with FIG. 1A, FIG. 1B, FIG. 2A, and FIG. 2B.

FIG. 1A and FIG. 1B are exemplary sequence flow diagrams illustrating a problem associated with a User Equipment (UE) registration with an Access and Mobility Management Function (AMF) during the disaster condition, when a UE 10 moves from an old AMF 20 to a new AMF 30, according to an embodiment of the disclosure.

Referring to FIG. 1A: At step 11, the UE 10 receives the cellular service from the Network-A (e.g., PLMN) and the UE 10 detects that the PLMN with the Disaster condition (PLMN-D). In this exemplary sequence flow diagram, the PLMN-D is the PLMN with the disaster (i.e., disaster condition), whereas a PLMN-A is a forbidden PLMN of the UE 10 that is alive and not subject to the disaster condition. The PLMN-A may provide a disaster roaming service to the UE 10 associated with the PLMN-D. Further, a PLMN-D1 is an allowable PLMN for the UE 10, as it is not on a Forbidden PLMN List (FPLMN List) of the UE 10 and has been in the disaster condition. Similarly, a PLMN-D2 is an allowed PLMN for the UE 10, i.e., it is not on the FPLMN list of the UE 10, and it has been in the disaster condition.

At step 12, the PLMN-A broadcasts an indication of accessibility for the disaster roaming service to the UE 10. The PLMN-A optionally broadcasts a list of PLMN(s) with the disaster condition (e.g., PLMN-D1, PLMN-D2) for which the disaster roaming service is offered by the PLMN-A in the impacted area.

At step 13, the UE 10 supports the MINT or disaster roaming. The UE 10 registers using a 5GS registration type value as “disaster roaming initial registration” or using the 5GS registration type value as “disaster roaming mobility registration updating” on the PLMN-A, where the PLMN-A is present in the FPLMN list of the UE 10. Additionally, the PLMN-A provides the disaster roaming service to the UE 10 on behalf of the PLMN-D1 (which is allowable or not a part of UE's FPLMN list and has faced the disaster). Additionally, the UE 10 registers on old AMF 20 (i.e., PLMN-A of the old AMF 20) for the disaster roaming service.

At step 14, the UE 10 triggers a registration procedure due to any of the reasons defined in 3GPP TS 24.501 v17.7.1 (e.g., if the UE 10 moves out of a registration area or any other reason). The serving AMF of the UE 10 may change from the old AMF 20 to the new AMF 30 (i.e., different from the old AMF 20 on which the UE 10 was previously registered).

Referring to FIG. 1B: At step 15, the new AMF 30 of the UE 10 may trigger a UE context transfer request and receive a UE context. For instance, through a Namf_Communication_UEContextTransfer and/or a Namf_Communication_UEContextTransfer response service operation or any signalling message from the old AMF 20 of the UE. The UE context may be stored in the old AMF 20 to which the UE 10 may register for the disaster roaming service for the PLMN-D1 which has faced the disaster condition.

At step 16, the old AMF 20 may include a “disaster roaming” field as part of the UE context transfer to the new AMF 30 to indicate that the UE 10 may register for the disaster roaming service.

In the existing systems, one problem identified is that the new AMF 30 on which the UE 10 is triggering the registration procedure for the disaster roaming service cannot determine the PLMN with the disaster condition. Because the UE context in AMF (e.g., old AMF 20) does not include or indicate the PLMN with disaster condition (for example, PLMN-D1) which has faced the disaster condition and for which the UE 10 was previously receiving the disaster roaming service from the old AMF 20. Without determining the PLMN with the disaster condition for which the disaster roaming service must be supplied to the UE 10, the new AMF 30 may be unable to determine whether to accept or reject the registration procedure for the UE 10. For example, if the new AMF 30 does not offer the disaster roaming service for the UE 10 for the PLMN-D1, the new AMF 30 cannot identify the same without first determining the PLMN with the disaster condition for which the UE 10 was previously registered for the disaster roaming service. Currently, there are no existing systems for the new AMF 30 to determine the PLMN with the disaster condition (e.g., PLMN-D1) which has faced the disaster condition and for which the UE 10 was previously receiving the disaster roaming service on the old AMF 20.

FIG. 2A and FIG. 2B are exemplary sequence flow diagrams illustrating a problem associated with the UE registration with the PLMN-A 40 during the disaster condition, according to an embodiment of the disclosure.

Referring to FIG. 2A: At step 21, the UE 10 receives the cellular service from the Network-A (e.g., PLMN) and the UE 10 detects that the PLMN with the Disaster condition (PLMN-D). In this exemplary sequence flow diagram, the PLMN-D is the PLMN with disaster condition, whereas the PLMN-A 40 is the forbidden PLMN of the UE 10 that is alive and not subject to the disaster condition. The PLMN-A 40 may provide the disaster roaming service to the UE 10 associated with the PLMN-D. Further, the PLMN-D1 is the allowable PLMN for the UE 10, as it is not on the forbidden PLMN List (FPLMN List) of the UE 10 and has been in the disaster condition. Similarly, the PLMN-D2 is an allowed PLMN for the UE 10, i.e., it is not on the FPLMN list of the UE 10, and it has been in the disaster condition.

At step 22, the PLMN-A 40 broadcasts an indication of accessibility for the disaster roaming service to the UE 10. The PLMN-A 40 optionally broadcasts the list of PLMN(s) with the disaster condition (e.g., PLMN-D1, PLMN-D2) for which the disaster roaming service is offered by the PLMN-A 40 in the impacted area.

At step 23, the UE 10 supports the MINT or disaster roaming. The UE 10 registers using the 5GS registration type value as “disaster roaming initial registration” or using the 5GS registration type value as “disaster roaming mobility registration updating” on the PLMN-A 40, where the PLMN-A 40 is present in the FPLMN list of the UE 10. Additionally, the PLMN-A 40 provides the disaster roaming service to the UE 10 on behalf of the PLMN-D1 (which is allowable. i.e., not the part of UE's FPLMN list and has faced the disaster condition).

At step 24, the PLMN-A 40 stops broadcasting the disaster roaming service for the PLMN-D1 or stops including the PLMN-D1 in the “list of PLMN(s) with disaster condition for which disaster roaming is offered by the available PLMN in the impacted area” but broadcasts disaster roaming service for the PLMN-D2 or includes or adds the PLMN-D2 as the PLMN(s) with disaster condition in the “list of PLMN(s) with the disaster condition for which the disaster roaming is offered by the available PLMN in the impacted area”.

Referring to FIG. 2B: At step 25, apart from the PLMN-A 40, the UE 10 determines that there are no other available PLMN(s) providing the disaster roaming service to the UE 10. Optionally, no PLMN is permitted to deliver normal services to the UE 10.

In the existing systems, another problem 26 identified is that the existing systems do not define how the UE 10 would use the disaster roaming service from the PLMN-A 40 for other PLMN(s) with the disaster condition (for example, PLMN-D2) when the UE 10 was initially registered on the PLMN-A 40 for the disaster roaming service for the PLMN-D1 (which has faced the disaster condition).

Thus, it is desired to address the above-mentioned disadvantages or other shortcomings or at least provide a useful alternative for managing the UE registration during the disaster condition.

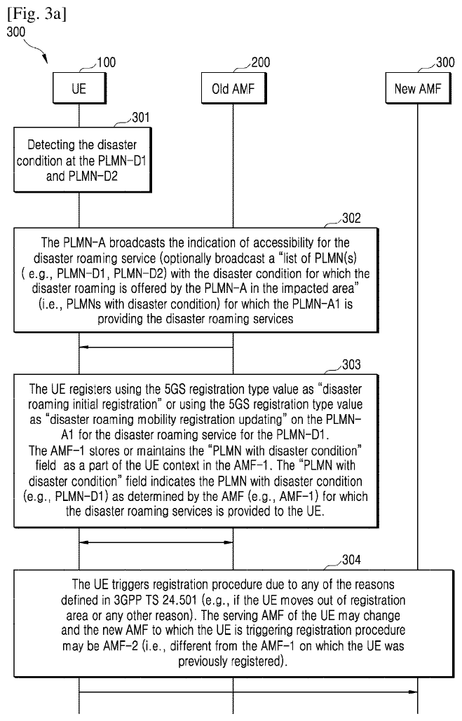

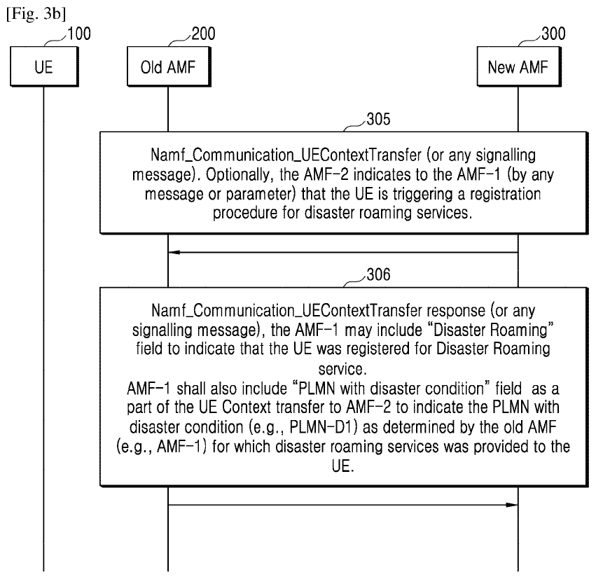

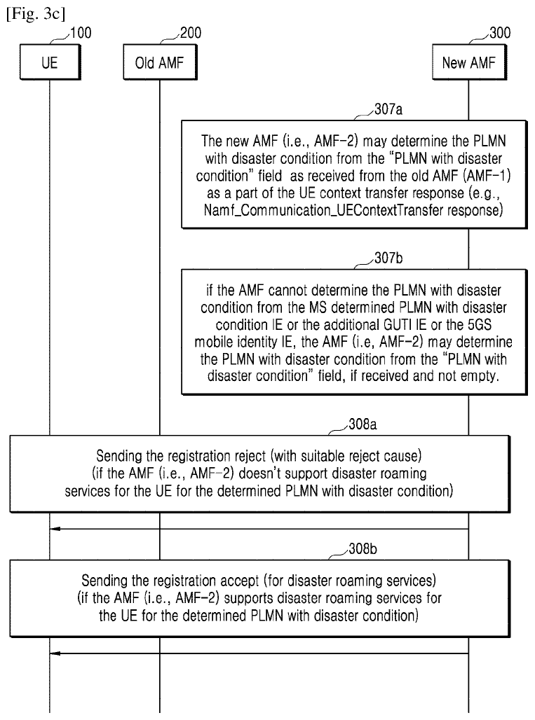

To address the above-mentioned challenges (i.e., FIG. 1A, FIG. 1B, FIG. 2A, and FIG. 2B), a disclosed method provides a unique strategy for managing the UE registration with the AMF and/or PLMN-A during the disaster condition, as described in conjunction with FIG. 3A to FIG. 10.

Throughout this disclosure, the terms “old AMF” and “first AMF” are used interchangeably and mean the same. Throughout this disclosure, the terms “new AMF” and “second AMF” are used interchangeably and mean the same.

Referring now to the drawings, and more specifically to FIGS. 3A to 10, where similar reference characters consistently represent equivalent aspects throughout the figures, preferred embodiments are illustrated.

FIG. 3A, FIG. 3B and FIG. 3C are exemplary sequence flow diagrams illustrating a method 300 for managing the UE registration with the AMF (e.g., 200 and 300) during the disaster condition, according to an embodiment of the disclosure.

Referring to FIG. 3A: At step 301, the method 300 includes receiving a cellular service from a Network-A (e.g., PLMN) and detecting that a PLMN is in a disaster condition (e.g., PLMN-D1 and PLMN-D2). The PLMN-D1 is the allowable PLMN for the UE 100, as it is not on the forbidden PLMN List (FPLMN list) of the UE 100 and has been in the disaster condition. Similarly, the PLMN-D2 is an allowed PLMN for the UE 100, i.e., it is not on the FPLMN list of the UE 100, and has been in the disaster condition.

At step 302, the method 300 includes detecting that a PLMN-A is part of the FPLMN list, where the PLMN-A is alive. Further, the PLMN-A may broadcast an indication of accessibility for a disaster roaming service to the UE 100. Furthermore, the PLMN-A may optionally broadcast a “list of PLMN(s) with disaster condition (e.g., PLMN-D1 and PLMN-D2) for which the disaster roaming service is offered by the available PLMN in an impacted area”.

At step 303, the method 300 includes detecting that the UE 100 may support a disaster roaming or Minimization of Service Interruption (MINT) system. Further, the UE 100 may select and register using a 5GS registration type value as “disaster roaming initial registration” or using a 5GS registration type value as “disaster roaming mobility registration updating” on the PLMN (e.g., PLMN-A) which is present in the FPLMN list of the UE 100. The PLMN-A may provide the disaster roaming service to the UE 100 on behalf of the PLMN (i.e., PLMN-D1) (which is allowable or not a part of the FPLMN list and has faced the disaster situation).

According to an embodiment of the disclosure, the old AMF 200 may store or maintain the “PLMN with disaster condition” field as a part of a UE context in the old AMF 200, as shown in Table-6 below. The “PLMN with disaster condition” field may indicate that the PLMN with the disaster condition (e.g., PLMN-D1) is determined by the old AMF 200 for which the disaster roaming services is provided to the UE 100.

TABLE 6

| Field | Description |
|---|---|
| SUPI | SUPI (Subscription Permanent Identifier) is |
| | the subscriber's permanent identity in 5GS. |
| Disaster | Indicates the UE is registered for Disaster |
| Roaming | Roaming service. |
| PLMN | This is the PLMN of the UE which has faced |
| with disaster | disaster condition |
| condition | |
| Field | Description |

According to an embodiment of the disclosure, the old AMF 200 may store or maintain the “PLMN with disaster condition” field as a part of the UE context in the old AMF 200 only when the UE 100 is registering for the disaster roaming services (i.e., when UE is indicating 5GS registration type one of the “disaster roaming initial registration” or “disaster roaming mobility registration updating”).

According to an embodiment of the disclosure, the old AMF 200 may not store or not maintain the “PLMN with disaster condition” field as a part of the UE context in the old AMF 200 when the UE 100 is registering for normal services and not for the disaster roaming services i.e., when the 5GS registration type is configured to one of the following:
a. Initial registration;
b. Mobility registration updating;
c. Periodic registration updating;
d. Emergency registration; and
e. SNPN onboarding registration.

According to an embodiment of the disclosure, the old AMF 200 may update the “PLMN with disaster condition” field as a part of the UE context in the old AMF 200 with a value to indicate that there is no PLMN with the disaster condition as determined by the old AMF 200 or indicated by the UE 100 or keep the field as an empty or NULL value.

According to an embodiment of the disclosure, the old AMF 200 may delete any PLMN stored in the “PLMN with disaster condition” field as a part of the UE context in the old AMF 200 when the UE 100 is registering for the normal services and not for the disaster roaming services or when the UE 100 is no more registered to the old AMF 200 or triggered a deregistration procedure with the old AMF 200.

According to an embodiment of the disclosure, whenever the PLMN with the disaster condition as determined by the old AMF 200 changes, the old AMF 200 may update or change the “PLMN with disaster condition” field as a part of the UE context in the old AMF 200 with a new determined PLMN with the disaster condition.

According to an embodiment of the disclosure, the old AMF 200 may indicate or include the “PLMN with disaster condition” field as a part of a UE context transfer (e.g., Namf_Communication_UEContextTransfer response) when requested by any of the Network Functions (NF) (e.g., AMF, SMF, UDM, etc.). The list of NFs is defined in 3GPP TS 23.501 v17.5.0/23.502 v17.5.0.

At step 304, the method 300 includes detecting that the UE 100 may trigger a registration procedure due to any of the reasons defined in 3GPP TS 24.501 v17.7.1. For example, if the UE 100 moves out of a registration area, a change in the registration area i.e., out of the TAI list, or any other reason. The serving AMF (old AMF 200) of the UE 100 may change to the new AMF (e.g., new AMF 300) to which the UE may trigger the registration procedure (i.e., different from the old AMF 200 on which the UE 100 was previously registered).

According to an embodiment of the disclosure, the UE 100 is registered for the disaster roaming service, and if there is a trigger to send a registration request message as described in 3GPP TS 24.501 v17.7.1. For example, when the UE 100 detects that a current TAI is not in a list of tracking areas that the UE 100 is previously registered in the AMF/network) then the UE 100 may include an MS-determined PLMN with the disaster condition and set the 5GS registration type to at least one of the following:
a. Initial registration;
b. Mobility registration updating;
c. Periodic registration updating;
d. Emergency registration;
c. SNPN onboarding registration;
f. Disaster roaming mobility registration updating; and
g. Disaster roaming initial registration.

Referring to FIG. 3B: At steps 305-306, the method 300 includes detecting that the new AMF 300 may trigger a UE context transfer request and receive the UE context (e.g., through Namf_Communication_UEContextTransfer and/or Namf_Communication_UEContextTransfer response service operation or any signalling message) from the old AMF 200 (i.e., the UE context stored in the old AMF 200 to which the UE 100 may register for the disaster roaming services for PLMN-D1 which has faced the disaster situation). Further, the old AMF 200 may include “Disaster Roaming” field as part of the UE context transfer to the new AMF 300 to indicate that the UE was registered for the disaster roaming service, as shown in Table-7 below.

TABLE 7

| | | | |
|---|---|---|---|
| disasterRoamingInd | Boolean | C | This IE shall be |
| | | | present if the UE is |
| | | | registered for disaster |
| | | | roaming. It may be present |
| | | | otherwise. |
| | | | When present, this IE |
| | | | shall be set as follows: |
| | | | true: UE is |
| | | | registered for Disaster |
| | | | Roaming service; |
| | | | false |
| | | | (default): UE is not |
| | | | registered for Disaster |
| | | | Roaming service. |
| disasterPlmn | PLMNId | C | This IE shall be |
| | | | included if the |
| | | | disasterRoamingInd is |
| | | | present and set to “true”. |
| | | | When present, this IE |
| | | | includes the PLMN of the UE |
| | | | which has faced disaster |
| | | | condition |

According to an embodiment of the disclosure, the old AMF 200 may also include the “PLMN with disaster condition” field as a part of the UE context transfer to the new AMF 300 to indicate the PLMN with the disaster condition (e.g., PLMN-D1) as determined by the old AMF 200 for which the disaster roaming services was provided to the UE 100.

According to an embodiment of the disclosure, the old AMF 200 may only include the “PLMN with disaster condition” field as a part of the UE context transfer to the new AMF 300 if the UE 100 is registered for the disaster roaming services.

According to an embodiment of the disclosure, the old AMF 200 may only include the “PLMN with disaster condition” field as a part of the UE context transfer to the new AMF 300 if the “PLMN with disaster condition” field is present and the “PLMN with disaster condition” field in the UE context in the AMF is not empty.

According to an embodiment of the disclosure, the old AMF 200 may only include the “PLMN with disaster condition” field as a part of the UE context transfer to the new AMF 300 if the new AMF 300 indicates to the old AMF 200 (by any message or parameter) that the UE 100 is triggering a registration procedure for the disaster roaming services.

According to an embodiment of the disclosure, the old AMF 200 may only include the “PLMN with disaster condition” field as a part of the UE context transfer to the new AMF 300 if the “Disaster Roaming” field is present as a part of the UE context in the AMF and/or the “Disaster Roaming” field is not empty or the “Disaster Roaming” field is set to a value to indicate that the UE 100 is registered for the disaster roaming services.

According to an embodiment of the disclosure, the above method, and procedures for maintaining or transferring the UE context are shown using the old AMF 200 and the new AMF 300 as an example. However, the same or similar procedures, as stated in an embodiment, are applicable for storing/maintaining or transferring the UE context transfer (e.g., through Namf_Communication_UEContextTransfer and/or Namf_Communication_UEContextTransfer response service operation) for/between any Network Functions (NF(s)) (e.g., AMF, SMF, UDM, etc.).

Referring to FIG. 3C: At steps 307a-307b, the method 300 includes determining, by the new AMF 300, the PLMN with disaster condition from the “PLMN with disaster condition” field as received from the old AMF 200 (and/or UDM, PCF, etc.) as a part of the UE context transfer response (e.g., Namf_Communication_UEContextTransfer response) or any other message or service operation or any other signal) and optionally, if the received “PLMN with disaster condition” field is not empty. Optionally if the “Disaster Roaming” field is set to a value to indicate that the UE 100 is registered for the disaster roaming services i.e., in general, the old AMF 200 indicates that the UE 100 is registered for the disaster roaming services.

According to an embodiment of the disclosure, based on a disaster roaming agreement arrangement between mobile network operators optionally only if the “Disaster Roaming” field indicates that the UE 100 is registered for the disaster roaming service as received from some other network function (e.g., old AMF 200, UDM, PCF, etc.) as a part of for example the UE context received from the old AMF 200 and/or the “Disaster Roaming” field is not empty or the “Disaster Roaming” field is set to a value to indicate that the UE 100 is registered for the disaster roaming services (i.e., in general, the old AMF 200 may indicate that the UE 100 is registered for the disaster roaming services).

According to an embodiment of the disclosure, the new AMF 300 may determine the PLMN with the disaster condition using any of the above methods/embodiments in any priority or in any combination, or a random order.

According to an embodiment of the disclosure, the new AMF 300 may use the “PLMN with disaster condition” field received from the old AMF 200 as a part of the UE context transfer response only if the UE 100 is triggering the registration procedure for the disaster roaming services (i.e., if 5GS registration type IE in the registration procedure (e.g., REGISTRATION REQUEST message) is set to one of “disaster roaming initial registration” or “disaster roaming mobility registration updating”.

According to an embodiment of the disclosure, the new AMF 300 may use the “PLMN with disaster condition” field received from the old AMF 200 as a part of the UE context transfer response if the UE 100 is indicating any 5GS registration type other than the “disaster roaming initial registration” or “disaster roaming mobility registration updating” i.e., when the 5GS registration type is configured to one of the following:
a. Initial registration;
b. Mobility registration updating;
c. Periodic registration updating;
d. Emergency registration; and
c. SNPN onboarding registration.

According to an embodiment of the disclosure, the new AMF 300, on which the UE 100 is triggering registration procedure, may determine the PLMN with the disaster condition from the “PLMN with disaster condition” field as received from the old AMF 200 as a part of the UE context transfer response (e.g., Namf_Communication_UEContextTransfer response) or any other message or service operation or any other signal, as described below herein.
a. The MS may determine the PLMN with the disaster condition IE included in the REGISTRATION REQUEST message, the new AMF 300 may determine the PLMN with the disaster condition in the MS determined PLMN with the disaster condition IE;
b. The MS may determine the PLMN with the disaster condition IE is not included in the REGISTRATION REQUEST message and the additional GUTI IE is included in the REGISTRATION REQUEST message and contains 5G-GUTI of a PLMN of the country of the PLMN providing disaster roaming, the new AMF 300 may determine the PLMN with disaster condition in the PLMN identity of the 5G-GUTI.
c. The MS may determine the PLMN with the disaster condition IE and the additional GUTI IE are not included in the REGISTRATION REQUEST message, and:
i. The 5GS mobile identity IE contains 5G-GUTI of a PLMN of the country of the PLMN providing disaster roaming, the AMF may determine the PLMN with the disaster condition in the PLMN identity of the 5G-GUTI; or
ii. The 5GS mobile identity IE contains SUCI of the PLMN of the country of the PLMN providing disaster roaming, the AMF may determine the PLMN with disaster condition in the PLMN identity of the SUCI;
d. The MS may determine the PLMN with the disaster condition IE is not included in the REGISTRATION REQUEST message, NG-RAN of the PLMN providing disaster roaming broadcasts disaster roaming indication, and:
i. The additional GUTI IE is included in the REGISTRATION REQUEST message and contains 5G-GUTI of a PLMN of a country other than the country of the PLMN providing disaster roaming; or
ii. The additional GUTI IE is not included and the 5GS mobile identity IE contains 5G-GUTI or SUCI of a PLMN of a country other than the country of the PLMN providing disaster roaming;
iii. The new AMF 300 may determine the PLMN with the disaster condition from the “PLMN with disaster condition” field, if received from the old AMF 200 as a part of the UE context transfer response (e.g., Namf_Communication_UEContextTransfer response) and optionally, if the received “PLMN with disaster condition” field is not empty.
e. The new AMF 300 may determine the PLMN with the disaster condition based on the disaster roaming agreement arrangement between mobile network operators.
f. The new AMF 300 may determine the PLMN with the disaster condition using any of the above methods in any priority order (for example the AMF may follow the above-mentioned steps a, b, c, d, and e in priority order otherwise the AMF may also follow the following order: a, b, c, c, and d or in any combination or in random order.

According to an embodiment of the disclosure, the new AMF 300 may use the “PLMN with disaster condition” field received from the old AMF 200 as a part of the UE context transfer response only if the UE 100 is triggering the registration procedure for the disaster roaming services (i.e., if the 5GS registration type IE in the registration procedure (e.g., REGISTRATION REQUEST message) is set to one of “disaster roaming initial registration” or “disaster roaming mobility registration updating”.

According to an embodiment of the disclosure, the new AMF 300 may use “PLMN with disaster condition” field received from the old AMF 200 as a part of the UE context transfer response if the UE 100 is registering for the normal services and not for the disaster roaming services (i.e., when the UE 100 is indicating any 5GS registration type other than “disaster roaming initial registration” or “disaster roaming mobility registration updating”), i.e., when the 5GS registration type is configured to one of the following:
a. Initial registration;
b. Mobility registration updating;
c. Periodic registration updating;
d. Emergency registration; and
c. SNPN onboarding registration.

At steps 308a-308b, the method 300 includes determining, by the new AMF 300, whether the new AMF 300 supports the disaster roaming services for the UE 100 for the determined PLMN with the disaster condition (e.g., PLMN-D1).

According to an embodiment of the disclosure, at step 308a, if the new AMF 300 doesn't support the disaster roaming services for the UE 100 for the determined PLMN with the disaster condition. For example, one of the following reasons:
a. As per the roaming agreement for the disaster roaming services with an HPLMN of the UE 100 does not exist; or
b. The determined PLMN with the disaster condition is a forbidden PLMN of the UE 100; or
c. Due to some other reasons, the AMF (e.g., the new AMF 300) may reject the registration procedure of the UE 100.

Upon detecting the above-mentioned reasons, the new AMF 300 may provide the UE 100 with an appropriate 5GMM reject cause (e.g., 5GMM Reject Cause #80 (Disaster roaming for the determined PLMN with disaster condition not allowed) or #11 “PLMN not allowed” or #13 “Roaming not allowed in this tracking area” or #12 (tracking area not allowed) or #15 No suitable cells in tracking area or any other appropriate reject causes. For a period of, for example, 12 to 24 hours, the UE 100 may not attempt to register for the disaster roaming service on the PLMN-A for the determined PLMN with the disaster condition. For example, the UE 100 may not seek to register for the disaster roaming on the PLMN-A over a period of, for example, 3 to 10 minutes or the UE 100 may not seek to register for the disaster roaming on the PLMN-A with MS determined PLMN with disaster condition (i.e., combination of PLMN-A+PLMN-D) over a period of, for example, 3 to 10 minutes. The UE may execute the PLMN selection in accordance with 3GPP TS 23.122 v17.7.1.

According to an embodiment of the disclosure, at step 308b, if the new AMF 300 supports the disaster roaming services for the UE 100 for the determined PLMN with the disaster condition, the AMF (e.g., new AMF 300) may accept the registration procedure of the UE 100 and provide the disaster roaming services to the UE 100 for the determined PLMN with the disaster condition. The AMF (e.g., new AMF 300) may update the “PLMN with disaster condition” field as a part of the UE context in the AMF (e.g., new AMF 300) with the PLMN with disaster condition, if any, as determined by the new AMF 300. The new AMF 300 may provide a registration accept message to the UE 100 and indicate it registered for the disaster roaming service.

For example, if the new AMF 300 determines that the disaster condition applies to the determined PLMN with disaster condition, and the UE 100 is allowed to be registered for the disaster roaming services. In the REGISTRATION ACCEPT message, the new AMF 300 may set the disaster roaming registration result value bit to “no additional information” in the 5GS registration result IE. If the new AMF 300 determines that the UE 100 can be registered to the PLMN for normal service, the new AMF 300 may set the disaster roaming registration result value bit in the 5GS registration result IE to “request for registration for the disaster roaming service accepted as registration not for disaster roaming service” in the REGISTRATION ACCEPT message or any other IE or new code point, etc.

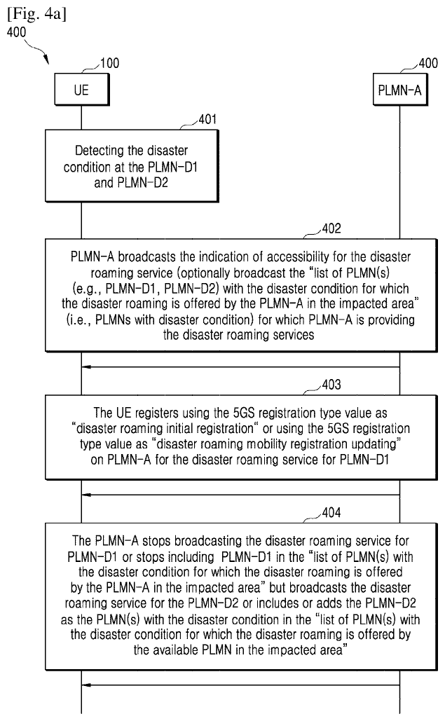

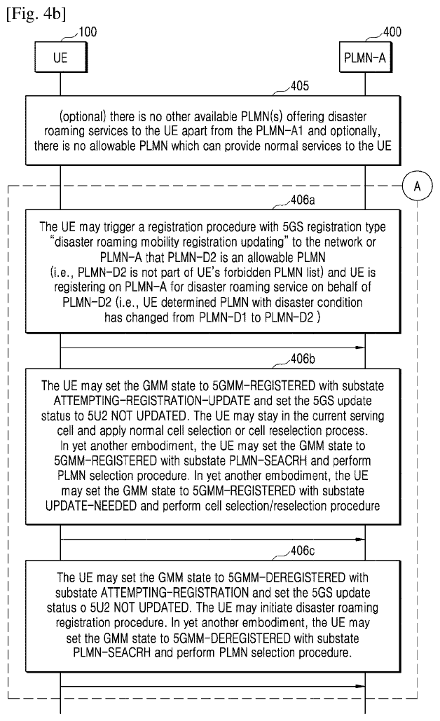

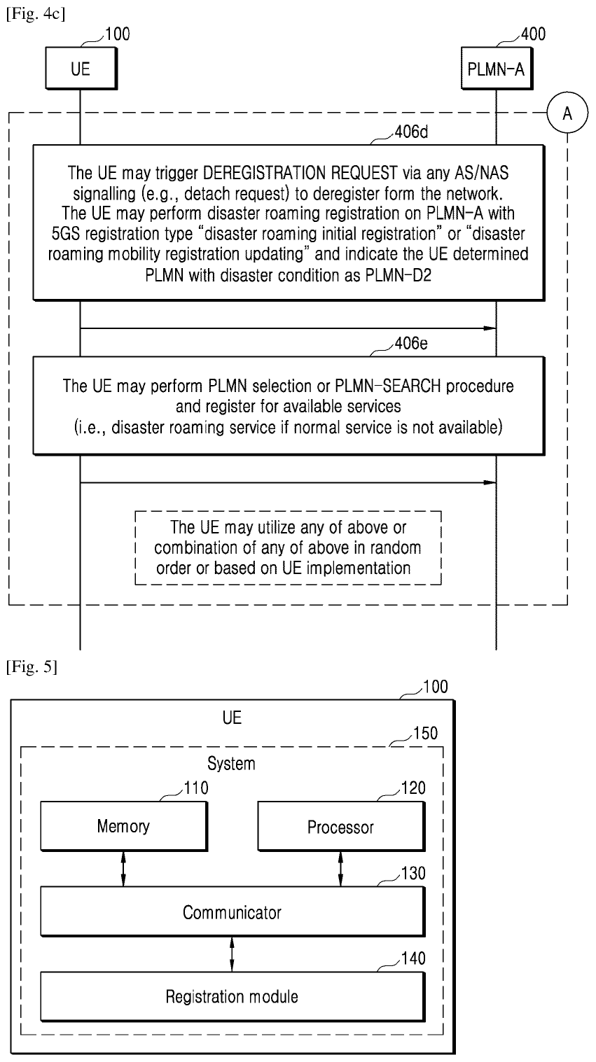

FIG. 4A, FIG. 4B and FIG. 4C are exemplary sequence flow diagrams illustrating a method 400 for managing the UE registration with the PLMN-A 400 during the disaster condition, according to an embodiment of the disclosure.

Referring to FIG. 4A: At step 401, the method 400 includes receiving the cellular service from the Network-A (e.g., PLMN) and detecting that the PLMN is in the disaster condition (e.g., PLMN-D1 and PLMN-D2), which relates to step 301 of FIG. 3A. The PLMN-D1 is the allowable PLMN for the UE 100, as it is not on the forbidden PLMN List (FPLMN list) of the UE 100 and has been in the disaster condition. Similarly, the PLMN-D2 is the allowed PLMN for the UE 100, i.e., it is not on the FPLMN list of the UE 100, and it has been in the disaster condition.

At step 402, the method 400 includes detecting that the PLMN-A 400 is part of the FPLMN list, where the PLMN-A 400 is alive, which relates to step 302 of FIG. 3A. Further, the PLMN-A 400 may broadcast an indication of accessibility for the disaster roaming service to the UE 100. Furthermore, the PLMN-A 400 may optionally broadcast a “list of PLMN(s) with disaster condition (e.g., PLMN-D1 and PLMN-D2) for which the disaster roaming service is offered by the available PLMN in the impacted area”.

At step 403, the method 400 includes detecting that the UE 100 may support the disaster roaming or MINT system, which relates to step 303 of FIG. 3A. Further, the UE 100 may select and register using the 5GS registration type value as “disaster roaming initial registration” or using the 5GS registration type value as “disaster roaming mobility registration updating” on the PLMN (e.g., PLMN-A) which is present in the FPLMN list of the UE 100. The UE 100 may indicate MS determined PLMN with disaster condition as the PLMN-D1. The PLMN-A 400 may provide the disaster roaming service to the UE 100 on behalf of the PLMN (i.e., PLMN-D1) (which is allowable or not a part of the FPLMN list and has faced the disaster situation).

At step 404, the method 400 includes detecting that the PLMN-A 400 may stop broadcasting the disaster roaming service for the PLMN-D1 or stop including the PLMN-D1 in the “list of PLMN(s) with the disaster condition for which the disaster roaming is offered by the PLMN-A 400 in the impacted area” but broadcasts the disaster roaming service for the PLMN-D2 or includes or adds the PLMN-D2 as the PLMN(s) with the disaster condition in the “list of PLMN(s) with the disaster condition for which the disaster roaming is offered by the available PLMN in the impacted area”.

Referring to FIG. 4B: At step 405, the method 400 includes detecting that there is no other available PLMN(s) offering the disaster roaming services to the UE 100 apart from the PLMN-A 400 and optionally, there is no allowable PLMN that can provide the normal services to the UE 100.

According to an embodiment of the disclosure, the UE 100 may determine that the current PLMN with the disaster condition with which the UE 100 is registered is no longer broadcasted, i.e., the last PLMN with the disaster condition UE 100 indicated to network (FPLMN) during the disaster roaming registration is no longer broadcasted, or if it is broadcasted, there is also a higher priority PLMN with the disaster condition in the area. When the UE 100 moves out of its registered area (e.g., TAI list), the UE 100 may optionally ascertain this. According to an embodiment of the disclosure, at least one of the triggers to send NAS messages, such as registration request messages. The triggers are listed in TS 24.501 v17.7.1. For example, the UE travels out of its recorded area, i.e., the TAI list. Additionally, the UE 100 may perform at least one of the below steps “A” (406a to 406e) in any combination or any order.

At step 406a, the UE 100 may trigger a registration procedure with the 5GS registration type “disaster roaming mobility registration updating” to indicate to the network or PLMN-A 400 that the PLMN-D2 is an allowable PLMN (i.e., PLMN-D2 is not part of the FPLMN List) and/or the UE 100 is registering on the PLMN-A 400 for the disaster roaming services on behalf of the PLMN-D2 (i.e. the UE/MS determined/indicated PLMN with the disaster condition is now the PLMN-D2), i.e., new or changed PLMN with disaster condition is PLMN-D2. The UE may indicate MS-determined PLMN with the disaster condition as the PLMN-D2 in any NAS message like a registration request message using the MS/UE 100 determined PLMN with the disaster condition IE or 5G-GUTI or additional GUTI IE. According to an embodiment of the disclosure, the 5GS registration type is configured to one of the following:
a. Initial registration;
b. Mobility registration updating;
c. Periodic registration updating;
d. Emergency registration;
c. SNPN onboarding registration;
f. Disaster roaming mobility registration updating; and
g. Disaster roaming initial registration.

At step 406b, the UE 100 may enter one of the 5GMM sublayer states (e.g., a 5GMM-REGISTERED.ATTEMPTING-REGISTRATION-UPDATE state) and the UE 100 may optionally set the 5GS update status to a 5U2 NOT UPDATED. Optionally, the UE 100 may stay in the current serving cell and apply normal cell selection or cell reselection process.

According to an embodiment of the disclosure, the UE 100 may enter a 5GMM-REGISTERED.PLMN-SEARCH state and perform PLMN selection procedure as described in 3GPP 23.122 v17.7.1.

According to an embodiment of the disclosure, the UE 100 may enter one of the 5GMM sublayer states (e.g., 5GMM-REGISTERED.UPDATE-NEEDED) and perform cell selection/reselection procedure.

According to an embodiment of the disclosure, the UE 100 may enter one of the 5GMM sublayer states (e.g., 5GMM-REGISTERED.PLMN-SEARCH state or 5GMM-REGISTERED.NO-CELL-AVAILABLE or 5GMM-REGISTERED.UPDATE-NEEDED or 5GMM-REGISTERED.ATTEMPTING-REGISTRATION-UPDATE state) or one of the EMM sublayer states if the UE 100 is on E-UTRA cell (i.e., LTE network) to perform PLMN selection as per 3GPP TS 23.122 v17.7.1.

At step 406c, the UE 100 may enter a 5GMM-DEREGISTERED.ATTEMPTING-REGISTRATION state and may optionally set the 5GS update status to the 5U2 NOT UPDATED. The UE 100 may initiate disaster roaming initial registration procedure.

According to an embodiment of the disclosure, the UE 100 may enter 5GMM-DEREGISTERED.PLMN-SEARCH state and perform the PLMN selection procedure.

Referring to FIG. 4C: At step 406d, the UE 100 may trigger DEREGISTRATION REQUEST via any AS/NAS Signalling (e.g., detach request) to deregister from the network. The UE 100 may perform the disaster roaming registration on the PLMN-A 400 with the 5GS registration type “disaster roaming initial registration” or “disaster roaming mobility registration updating” and optionally, indicate that the UE 100 is registering on the PLMN-A 400 for the disaster roaming services on behalf of the PLMN-D2 (i.e., the UE 100 determined/indicated PLMN with disaster condition is now the PLMN-D2). The UE 100 may indicate MS-determined PLMN with the disaster condition as the PLMN-D2 in any NAS message like a registration request message using MS/UE determined PLMN with disaster condition IE or 5G-GUTI.

At step 406e, the UE 100 may perform the PLMN selection or PLMN-SEARCH procedure and register for available services (i.e., normal services or disaster roaming services if normal services are not available).

According to an embodiment of the disclosure, the UE 100 may perform the PLMN selection as per “PLMN selection as per 3GPP TS 23.122 v17.7.1 without RPLMN” or “PLMN selection as per 3GPP Ts 23.122 v17.7.1 with RPLMN”.

According to an embodiment of the disclosure, the UE 100 may trigger the DEREGISTRATION REQUEST via any AS/NAS signalling (e.g., detach request) to deregister from the network. The UE 100 may perform the initial registration on any available and allowable PLMN with the 5GS registration type “initial registration”.

According to an embodiment of the disclosure, the UE 100 may perform the registration procedure on any available and allowable PLMN with any 5GS registration type other than “disaster roaming initial registration” and “disaster roaming mobility registration updating” (i.e., the UE 100 can register with the 5GS registration type not equal to disaster roaming initial registration or disaster roaming mobility registration updating).

According to an embodiment of the disclosure, the UE 100 may select and camp/attempt to camp on alternate/any PLMN/RAT/Access, if available.

According to an embodiment of the disclosure, the UE 100 may trigger the registration procedure for mobility and periodic registration update as described in 3GPP TS 24.501 v17.7.1.

According to an embodiment of the disclosure, if non-3GPP access is available in the same location, the UE 100 may select and camp on it. Alternatively, if non-3GPP access is available in the same area, the UE 100 may not select and camp on any non-3GPP access.

According to an embodiment of the disclosure, the UE 100 may perform emergency registration for emergency services on any 3GPP access or any RAT(s) or PLMN(s).

According to an embodiment of the disclosure, the UE 100 may not perform emergency registration for emergency services on any 3GPP access or any RAT(s) or PLMN(s).

According to an embodiment of the disclosure, the UE 100 may perform any of the above (406a to 406c) or a combination of any of the above in any order or random order or based on the UE implementation. Because of the various triggers from the UE 100 described in an embodiment, if the network function, such as AMF, receives a new PLMN with the disaster condition, such as PLMN-D2, it may store the newly received PLMN with the disaster condition on behalf of which AMF is providing the disaster roaming service to the UE 100, for example, as described in following points, may be executed in any order or priority or combination.

a. If the network function, such as AMF, determines the PLMN with the disaster condition from both the old AMF 200 (e.g., PLMN-D1) and the UE 100 (e.g., PLMN-D2), the AMF (e.g., new AMF 300) may treat the PLMN with the disaster condition for the UE 100 as PLMN-D2, i.e., the one received from the UE 100.

b. If the network function, such as AMF, determines the PLMN with the disaster condition from both the old AMF 200 (e.g., PLMN-D1) and the UE 100 (e.g., PLMN-D2), the AMF (e.g., new AMF 300) may treat the PLMN with the disaster condition received from the AMF as PLMN-D1.

c. The AMF (e.g., new AMF 300) may determine the PLMN with the disaster condition based on operator roaming agreements or based on new AMF implementation.

The new AMF 300 may determine the PLMN with the disaster condition in at least one of the methods discussed in this embodiment and uses this information to determine if the UE can get disaster roaming service, based on this determination the AMF (e.g., new AMF 300) determines whether registration accept has to be provided to the UE 100 or the registration reject message with appropriate reject cause has to be provided to the UE 100.

The UE 100 may determine that the disaster condition has ended, if the NG-RAN cell of the registered PLMN offering disaster roaming service broadcasts neither the disaster-related indication nor a “list of one or more PLMN(s) with disaster condition for which disaster roaming services is offered by the available PLMN” including the determined PLMN with Disaster Condition (as specified in 3GPP TS 23.122 v17.7.1 [5]). Upon determining that a disaster condition has ended the UE 100 may perform PLMN selection as specified in 3GPP TS 23.122 v17.7.1 [6].

FIG. 5 illustrates a block diagram of the UE 100 for managing the UE registration during the disaster condition, according to an embodiment of the disclosure. Examples of the UE 100 include, but are not limited to a smartphone, a tablet computer, a Personal Digital Assistance (PDA), an Internet of Things (IoT) device, etc.

According to an embodiment of the disclosure, the UE 100 comprises a system 150. The system 150 may include a memory 110, a processor 120, a communicator 130, and a registration module 140.

According to an embodiment of the disclosure, the memory 110 stores instructions to be executed by the processor 120 for managing the UE registration during the disaster condition, as discussed throughout the disclosure. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted as the memory 110 is non-movable. In some examples, the memory 110 can be configured to store larger amounts of information than the memory. In certain examples, a non-transitory storage medium may store data that can, over time, change (e.g., in random access memory (RAM) or cache). The memory 110 can be an internal storage unit, or it can be an external storage unit of the UE 100, a cloud storage, or any other type of external storage.

The processor 120 communicates with the memory 110, the communicator 130, and the registration module 140. The processor 120 is configured to execute instructions stored in the memory 110 and to perform various processes for managing the UE registration during the disaster condition, as discussed throughout the disclosure. The processor 120 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 130 is configured for communicating internally between internal hardware components and with external devices (e.g., server) via one or more networks (e.g., radio technology). The communicator 130 includes an electronic circuit specific to a standard that enables wired or wireless communication.

The registration module 140 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

According to an embodiment of the disclosure, the registration module 140 is configured to receive a service from the PLMN. The registration module 140 is further configured to detect the PLMN with the Disaster condition (PLMN-D), which may relate to step 301 of FIG. 3A. The registration module 140 is further configured to receive at least one disaster roaming service from an Alive forbidden PLMN (PLMN-A) upon detecting that the PLMN-D, where the PLMN-A is not in the disaster condition, which may relate to step 302 of FIG. 3A. The registration module 140 is further configured to send a first registration request to the first AMF 200 associated with the PLMN-A 400 for the at least one disaster roaming service for the PLMN-D, which may relate to step 303 of FIG. 3A. The first registration request comprises a PLMN with a disaster condition field and the PLMN with the disaster condition field indicates the PLMN associated with the disaster condition (PLMN-D) for which the at least one disaster roaming service is provided to the UE 100 from the PLMN-A 400. The registration module 140 is further configured to second registration request to the second AMF 300 for the at least one disaster roaming service for the PLMN-D, where the UE 100 moves out of the registration area associated with the first AMF 200, which may relate to step 304 of FIG. 3A. The registration module 140 is further configured to receive one of the registration accept message or the registration reject message from the second AMF 300 for the at least one disaster roaming service for the PLMN-D, which may relate to steps 308a-308b of FIG. 3C.

According to an embodiment of the disclosure, the registration module 140 is further configured to register with the PLMN-A 400 for the at least one disaster roaming service using the 5GS registration type value, the 5GS registration type value comprises at least one of the disaster roaming initial registration and the disaster roaming mobility registration updating, which may relate to step 303 of FIG. 3A.

According to an embodiment of the disclosure, the registration module 140 is further configured to access the at least one disaster roaming service from the second AMF 300 based on the registration accept message or the registration reject message and the registration reject message comprises the suitable reject cause, which may relate to steps 308a-308b of FIG. 3C.

According to an embodiment of the disclosure, the registration module 140 is further configured to perform, upon receiving the registration reject message, the PLMN selection mechanism (i.e., PLMN selection), which may relate to step 308a of FIG. 3C.

Although FIG. 5 shows various hardware components of the UE 100, but it is to be understood that other embodiments are not limited thereon. According to an embodiment of the disclosure, the UE 100 may include less or more number of components. Further, the labels or names of the components are used only for illustrative purposes and do not limit the scope of the disclosure. One or more components can be combined to perform the same or substantially similar functions for managing the UE registration during the disaster condition.

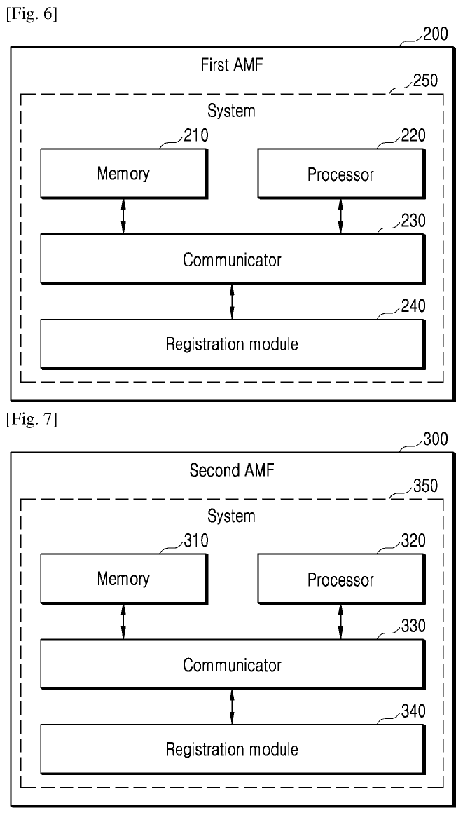

FIG. 6 illustrates a block diagram of the first AMF 200 for managing the UE registration during the disaster condition, according to an embodiment of the disclosure.

According to an embodiment of the disclosure, the first AMF 200 comprises a system 250. The system 250 may include a memory 210, a processor 220, a communicator 230, and a registration module 240.

According to an embodiment of the disclosure, the memory 210 stores instructions to be executed by the processor 220 for managing the UE registration during the disaster condition, as discussed throughout the disclosure. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted as the memory 210 is non-movable. In some examples, the memory 210 can be configured to store larger amounts of information than the memory. In certain examples, a non-transitory storage medium may store data that can, over time, change (e.g., in random access memory (RAM) or cache). The memory 210 can be an internal storage unit, or it can be an external storage unit of the first AMF 200, a cloud storage, or any other type of external storage.

The processor 220 communicates with the memory 210, the communicator 230, and the registration module 240. The processor 220 is configured to execute instructions stored in the memory 210 and to perform various processes for managing the UE registration during the disaster condition, as discussed throughout the disclosure. The processor 220 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 230 is configured for communicating internally between internal hardware components and with external devices (e.g., server) via one or more networks (e.g., radio technology). The communicator 230 includes an electronic circuit specific to a standard that enables wired or wireless communication.

The registration module 240 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

According to an embodiment of the disclosure, the registration module 240 is configured to receive the first registration request from the UE 100, which may relate to step 303 of FIG. 3A. The registration module 240 is further configured to store, upon receiving the first registration request the PLMN with the disaster condition field as a part of the UE context associated with the first registration request, which may relate to step 303 of FIG. 3A. The PLMN with the disaster condition field indicates that the PLMN with the Disaster condition (PLMN-D) for which at least one disaster roaming service is provided to the UE 100, where the at least one disaster roaming service is provided by the PLMN-A 400 associated with the first AMF 200. The registration module 240 is further configured to receive a UE context transfer request from the second AMF 300, which may relate to step 305 of FIG. 3B. The UE context transfer request comprises the Namf_Communication_UEContextTransfer request. The registration module 240 is further configured to send, upon receiving the UE context transfer request, the UE context transfer response to the second AMF 300 to manage the UE registration with the second AMF 300, which may relate to step 306 of FIG. 3B. The UE context transfer response comprises the Namf_Communication_UEContextTransfer response and the Namf_Communication_UEContextTransfer response comprises at least one of the disaster roaming field and the PLMN with the disaster condition field.

According to an embodiment of the disclosure, the registration module 240 is further configured to receive the UE context transfer request from the second AMF 300 when the UE 100 moves out of the registration area associated with the first AMF 200, which may relate to step 305 of FIG. 3B.

According to an embodiment of the disclosure, the registration module 240 is further configured to execute multiple steps to store the PLMN with the disaster condition field as the part of the UE context, which are given below.

The registration module 240 may determine whether the UE 100 registers with the PLMN-A 400 for the at least one disaster roaming service, which may relate to step 403 of FIG. 4A. The registration module 240 may be stored, in response to determining that the UE 100 registers with the PLMN-A 400 for the at least one disaster roaming service, the PLMN with the disaster condition field as the part of the UE context.

According to an embodiment of the disclosure, the registration module 240 is further configured to determine the UE 100 registers with the PLMN-A (400) for the at least one disaster roaming service using the 5GS registration type value, the 5GS registration type value comprises at least one of the disaster roaming initial registration and the disaster roaming mobility registration updating, which may relate to steps 406a to 406c of FIG. 4B and FIG. 4C.

Although FIG. 6 shows various hardware components of the first AMF 200, but it is to be understood that other embodiments are not limited thereon. According to an embodiment of the disclosure, the first AMF 200 may include less or more number of components. Further, the labels or names of the components are used only for illustrative purposes and do not limit the scope of the disclosure. One or more components can be combined to perform the same or substantially similar functions for managing the UE registration during the disaster condition.

FIG. 7 illustrates a block diagram of the second AMF 300 for managing the UE registration during the disaster condition, according to an embodiment of the disclosure.

According to an embodiment of the disclosure, the second AMF 300 comprises a system 350. The system 350 may include a memory 310, a processor 320, a communicator 330, and a registration module 340.

According to an embodiment of the disclosure, the memory 310 stores instructions to be executed by the processor 320 for managing the UE registration during the disaster condition, as discussed throughout the disclosure. The memory 310 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 310 may, in some examples, be considered a non-transitory storage medium. The term “non-transitory” may indicate that the storage medium is not embodied in a carrier wave or a propagated signal. However, the term “non-transitory” should not be interpreted as the memory 310 is non-movable. In some examples, the memory 310 can be configured to store larger amounts of information than the memory. In certain examples, a non-transitory storage medium may store data that can, over time, change (e.g., in random access memory (RAM) or cache). The memory 310 can be an internal storage unit, or it can be an external storage unit of the second AMF 300, a cloud storage, or any other type of external storage.

The processor 320 communicates with the memory 310, the communicator 330, and the registration module 340. The processor 320 is configured to execute instructions stored in the memory 310 and to perform various processes for managing the UE registration during the disaster condition, as discussed throughout the disclosure. The processor 320 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator 330 is configured for communicating internally between internal hardware components and with external devices (e.g., server) via one or more networks (e.g., radio technology). The communicator 330 includes an electronic circuit specific to a standard that enables wired or wireless communication.

The registration module 340 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

According to an embodiment of the disclosure, the registration module 340 is configured to receive the second registration request from the UE 100, which may relate to step 304 of FIG. 3A. The registration module 340 is further configured to send, upon receiving the second registration request, the UE context transfer request to the first AMF 200, which may relate to step 305 of FIG. 3B. The registration module 340 is further configured to receive the UE context transfer response comprising at least one of the PLMN-D and the disaster roaming field from the first AMF 200, which may relate to step 306 of FIG. 3B. The registration module 340 is further configured to determine whether the second AMF 300 supports at least one disaster roaming service for the UE 100 associated with the PLMN-D based on the at least one of the received PLMN-D and the disaster roaming field, which may relate to steps 307a-307b of FIG. 3C. The registration module 340 is further configured to send the registration accept message to the UE 100 in response to determining that the second AMF 300 supports at least one disaster roaming service for the UE 100 associated with the PLMN with the Disaster condition (PLMN-D), which may relate to step 308b of FIG. 3C. The registration module 340 is further configured to send the registration reject message to the UE 100 in response to determining that the second AMF 300 does not support at least one disaster roaming service for the UE 100 associated with the PLMN with the Disaster condition (PLMN-D), which may relate to step 308b of FIG. 3C.

Although FIG. 7 shows various hardware components of the second AMF 300, but it is to be understood that other embodiments are not limited thereon. According to an embodiment of the disclosure, the second AMF 300 may include less or more number of components. Further, the labels or names of the components are used only for illustrative purposes and do not limit the scope of the disclosure. One or more components can be combined to perform the same or substantially similar functions for managing the UE registration during the disaster condition.

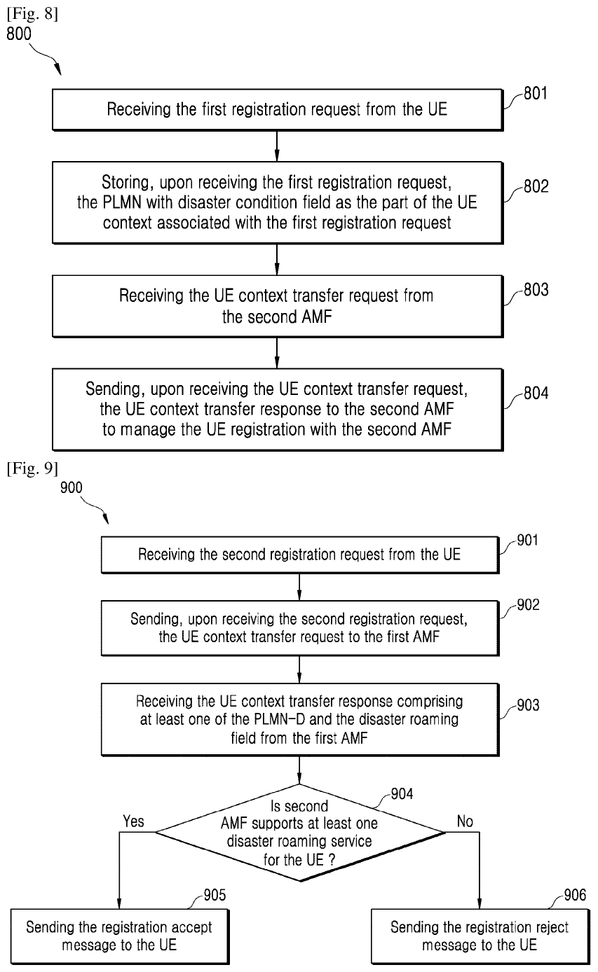

FIG. 8 is a flow diagram illustrating a method 800 for managing the UE registration with the first AMF 200 during the disaster condition, according to an embodiment of the disclosure.

At step 801, the method 800 includes receiving the first registration request from the UE 100, which may relate to step 303 of FIG. 3A.

At step 802, the method 800 includes storing, upon receiving the first registration request, the PLMN with the disaster condition field as the part of the UE context associated with the first registration request, which may relate to step 303 of FIG. 3A. According to an embodiment of the disclosure, the PLMN with the disaster condition field indicates that the PLMN with the Disaster condition (PLMN-D) for which at least one disaster roaming service is provided to the UE 100, where the at least one disaster roaming service is provided by the PLMN-A 400 associated with the first AMF 200.

According to an embodiment of the disclosure, the method 800 includes determining whether the UE 100 registers with the PLMN-A 400 for the at least one disaster roaming service. The method 800 further includes storing, in response to determining that the UE 100 registers with the PLMN-A 400 for the at least one disaster roaming service, the PLMN with the disaster condition field as the part of the UE context.

According to an embodiment of the disclosure, the method 800 includes determining the UE 100 registers with the PLMN-A 400 for the at least one disaster roaming service using the 5GS registration type value, the 5GS registration type value comprises at least one of the disaster roaming initial registration and the disaster roaming mobility registration updating.

At step 803, the method 800 includes receiving the UE context transfer request from the second AMF 300, which may relate to step 305 of FIG. 3B. According to an embodiment of the disclosure, the UE context transfer request comprises the Namf_Communication_UEContextTransfer request.

At step 804, the method 800 includes sending, upon receiving the UE context transfer request, the UE context transfer response to the second AMF 300 to manage the UE registration with the second AMF 300, which may relate to step 306 of FIG. 3B. According to an embodiment of the disclosure, the UE context transfer response comprises the Namf_Communication_UEContextTransfer response and the Namf_Communication_UEContextTransfer response comprises at least one of the disaster roaming field and the PLMN with the disaster condition field.

According to an embodiment of the disclosure, the method 800 includes receiving the UE context transfer request from the second AMF 300 when the UE 100 moves out of the registration area associated with the first AMF 200.

FIG. 9 is a flow diagram illustrating a method 900 for managing the UE registration with the second AMF 300 during the disaster condition, according to an embodiment of the disclosure.

At step 901, the method 900 includes receiving the second registration request from the UE 100, which may relate to step 304 of FIG. 3A.

At step 902, the method 900 includes sending, upon receiving the second registration request, the UE context transfer request to the first AMF 200, which may relate to step 305 of FIG. 3B. According to an embodiment of the disclosure, the UE context transfer request comprises the Namf_Communication_UEContextTransfer request.

At step 903, the method 900 includes receiving the UE context transfer response comprising at least one of the PLMN-D and the disaster roaming field from the first AMF 200, which may relate to step 306 of FIG. 3B.

At step 904, the method 900 includes determining whether the second AMF 300 supports the at least one disaster roaming service for the UE 100 associated with the PLMN-D based on the at least one of the received PLMN-D and the disaster roaming field, which may relate to steps 307a-307b of FIG. 3C.

At step 905, the method 900 includes sending the registration accept message to the UE 100 in response to determining that the second AMF 300 supports the at least one disaster roaming service for the UE 100 associated with the PLMN with the Disaster condition (PLMN-D), which may relate to step 308b of FIG. 3C.

At step 906, the method 900 includes sending the registration reject message to the UE 100 in response to determining that the second AMF 300 does not support the at least one disaster roaming service for the UE 100 associated with the PLMN with the Disaster condition (PLMN-D), which may relate to step 308a of FIG. 3C.

According to an embodiment of the disclosure, the method 900 includes receiving, upon detecting that UE moves out of a registration area associated with the first AMF 200, the second registration request from the UE 100, which may relate to step 304 of FIG. 3A.

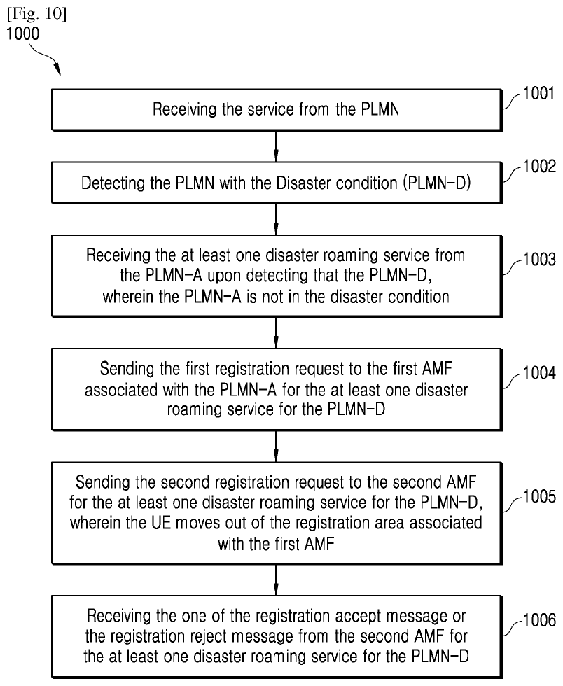

FIG. 10 is a flow diagram illustrating a method 1000 for managing the UE registration during the disaster condition, according to an embodiment of the disclosure.

At step 1001, the method 1000 includes receiving the service from the PLMN, which may relate to step 301 of FIG. 3A.

At step 1002, the method 1000 includes detecting the PLMN with the Disaster condition (PLMN-D), which may relate to step 301 of FIG. 3A.

At step 1003, the method 1000 includes receiving the at least one disaster roaming service from the PLMN-A 400 upon detecting that the PLMN-D, where the PLMN-A 400 is not in the disaster condition, which may relate to step 302 of FIG. 3A.

At step 1004, the method 1000 includes sending the first registration request to the first AMF 200 associated with the PLMN-A 400 for the at least one disaster roaming service for the PLMN-D, which may relate to step 303 of FIG. 3A.

According to an embodiment of the disclosure, the first registration request comprises the PLMN with the disaster condition field and the PLMN with the disaster condition field indicates the PLMN associated with the Disaster condition (PLMN-D) for which the at least one disaster roaming service is provided to the UE 100 from the PLMN-A 400.

According to an embodiment of the disclosure, the method 1000 includes registering with the PLMN-A 400 for the at least one disaster roaming service using the 5GS registration type value, the 5GS registration type value comprises the at least one of the disaster roaming initial registration and the disaster roaming mobility registration updating.

According to an embodiment of the disclosure, the method 1000 includes accessing the at least one disaster roaming service from the second AMF 300 based on the registration accept message or the registration reject message and the registration reject message comprises the suitable reject cause.

According to an embodiment of the disclosure, the method 1000 includes performing, upon receiving the registration reject message, the PLMN selection mechanism.

At step 1005, the method 1000 includes sending the second registration request to the second AMF 300 for the at least one disaster roaming service for the PLMN-D, where the UE 100 moves out of the registration area associated with the first AMF 200, which may relate to step 304 of FIG. 3A.

At step 1006, the method 1000 includes receiving the one of the registration accept message or the registration reject message from the second AMF 300 for the at least one disaster roaming service for the PLMN-D, which may relate to steps 308a-308b of FIG. 3C.

The disclosed method has one or more advantages such as the second AMF 300 on which the UE 100 is triggering the registration procedure for the disaster roaming service can determine the PLMN with the disaster condition, as the UE context in AMF (e.g., the first AMF 200) does include or indicate the PLMN with disaster condition (for example, PLMN-D1) which has faced the disaster condition and for which the UE 100 was previously receiving the disaster roaming service from the first AMF 200. By determining the PLMN with the disaster condition for which the disaster roaming service must be supplied to the UE 100, the second AMF 300 may be able to determine whether to accept or reject the registration procedure for the UE 100.

For example, if the second AMF 300 does not offer the disaster roaming service for the UE 100 for the PLMN-D1, the second AMF 300 may identify the same by determining the PLMN with the disaster condition for which the UE 100 was previously registered for the disaster roaming service. In other words, the second AMF 300 may determine the PLMN with the disaster condition (e.g., PLMN-D1) which has faced the disaster condition and for which the UE 100 was previously receiving the disaster roaming service on the first AMF 200.

Additionally, the disclosed method defines how the UE 100 may use the disaster roaming service from the PLMN-A 400 for other PLMN(s) with the disaster condition (for example, PLMN-D2) when the UE 100 was initially registered on the PLMN-A 400 for the disaster roaming service for the PLMN-D1 (which has faced the disaster condition).

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a first access and mobility management function (AMF), the method comprising:
receiving, from a user equipment (UE), a registration request message including information regarding a public land mobile network (PLMN) with a disaster condition, wherein the information regarding the PLMN with the disaster condition indicates a PLMN of the UE which has faced the disaster condition;
storing the information regarding the PLMN with the disaster condition included in the registration request message as a part of a UE context;
receiving, from a second AMF, a UE context transfer request message; and
transmitting, to the second AMF, a UE context transfer response message in response to the UE context transfer request message, the UE context transfer response message comprising the UE context.

17. The method of claim 16, wherein storing the information regarding the PLMN with the disaster condition includes storing the information regarding the PLMN with the disaster condition as the part of the UE context when the UE is registered for a disaster roaming service.

18. The method of claim 16, wherein the UE context further includes disaster roaming information indicating whether the UE is registered for a disaster roaming service.

19. The method of claim 16, wherein the registration request message includes registration type information indicating a disaster roaming initial registration and a disaster roaming mobility registration updating.

20. A method performed by a second access and mobility management function (AMF), the method comprising:
transmitting, to a first AMF, a user equipment (UE) context transfer request message;
receiving, from the first AMF, a UE context transfer response message comprising a UE context, wherein the UE context includes information regarding a public land mobile network (PLMN) with a disaster condition;
determining whether the second AMF supports a disaster roaming service for the PLMN with the disaster condition to a UE; and
in case that the second AMF determines not to support the disaster roaming service for the PLMN with disaster condition to the UE, transmitting, to the UE, a registration reject message indicating that the disaster roaming service for the PLMN with the disaster condition is not allowed.

21. The method of claim 20, wherein the information regarding the PLMN with the disaster condition indicates a PLMN of the UE which has faced the disaster condition.

22. The method of claim 20, wherein the information regarding the PLMN with the disaster condition is provided by the UE through a registration request message transmitted to the first AMF.

23. The method of claim 20, wherein the UE context further includes disaster roaming information indicating whether the UE is registered for the disaster roaming service.

24. The method of claim 20, wherein the registration reject message includes cause information, and the cause information indicates that the disaster roaming service for the PLMN with the disaster condition is not allowed.

25. A method performed by a user equipment (UE), the method comprising:
transmitting, to a first access and mobility management function (AMF), a registration request message including information regarding a public land mobile network (PLMN) with a disaster condition, wherein the information regarding the PLMN with the disaster condition indicates a PLMN of the UE which has faced disaster condition; and
receiving, from a second AMF, a registration reject message indicating that a disaster roaming service for the PLMN with the disaster condition is not allowed,
wherein the UE does not attempt to register for disaster roaming on the PLMN with the disaster condition for a certain period of time.

26. The method of claim 25, wherein the information regarding the PLMN with the disaster condition included in the registration request message is stored by the first AMF as a part of a UE context when the UE is registered for the disaster roaming service.

27. The method of claim 25, further comprising:
performing a PLMN selection.
